(19) United States
(12) Patent Application Publication
(10) Pub. No.: US 2011/0131883 A1
(43) Pub. Date: Jun. 9, 2011

(54) SLIDING DOOR FOR A VEHICLE

(75) Inventors: Gerhard Heuel, Olpe (DE); Michael Krehmke, Plettenberg (DE); Ralf Rottmann, Drolshagen (DE)

(73) Assignee: DURA Automotive Body & Glass Systems GmbH, Plettenberg (DE)

(21) Appl. No.: 12/960,695

(22) Filed: Dec. 6, 2010

(30) Foreign Application Priority Data
Dec. 7, 2009 (DE) 10 2009 057 325.9

(51) Int. Cl. B60J 5/00; E05F 5/08

(52) U.S. Cl. 49/212; 16/85

(57) ABSTRACT

A sliding door for a motor vehicle includes a guide rail and a sliding carriage which is longitudinally displaceably journaled at the guide rail and which is connected to the vehicle body by a multijoint. The sliding door furthermore includes a centering (42) at its end remote from the multijoint which is releasably connectable to a counter-bearing (48) at the body side. To improve such a sliding door, a damper (63) is provided for damping the movement of the sliding door (41) on the connection of the centering (42) to the counter-bearing (48).

### BACKGROUND OF THE INVENTION

The invention relates to a sliding door for a vehicle, in particular for a motor vehicle.

The sliding door includes a guide rail, a sliding carriage and a centering. The sliding carriage is longitudinally displaceably journalled at the guide rail and is connected by a multijoint to the vehicle body. The centering is provided at the end of the sliding door remote from the multijoint. It is releasably connected to a counter-bearing at the body side.

A sliding door of this kind is known from DE 10 2008 016 650 B3 to which reference is herewith explicitly made. In this sliding door, the multijoint includes a hinge bow which is rotatably journalled at the sliding carriage and at a body flange and a control lever which is rotatably journalled at the sliding carriage and at a or the body flange. The already known sliding door furthermore includes a first intermediate lever which is rotatably journalled at the control lever and a second intermediate lever which is rotatably journalled at the first intermediate lever and at the sliding carriage. The sliding door is rotatably and longitudinally displaceably journalled at the end remote from the multijoint by a centering. It can be locked there. The control lever has an extension at which the first intermediate lever is rotatably journalled. A guide pin is provided at the connection joint of the first intermediate lever and of the second intermediate lever and is guided in a guide track provided at the sliding door. The guide track extends in an inclined manner relative to the guide rail. The guide track in this respect extends in the direction away from the hinge bow in an outwardly inclined manner.

Another sliding door of the initially set forth kind is described in EP 2 008 846 A2 to which reference is likewise explicitly made. A drive rod is present here which is rotatably journalled at the control lever. The sliding door is rotatably and longitudinally displaceably journalled at the end remote from the multijoint by a centering. It can be locked there. The drive rod is rotatably journalled at the guide rail. The control lever has a lever arm at which the drive rod is rotatably journalled. A guide pin which is guided in a guide track provided at the sliding door is provided at an intermediate lever which is rotatably journalled at the sliding carriage.

A further sliding door of the initially set forth kind is known from the German patent application 10 2008 026 137.8 which has senior priority and is not pre-published; reference is likewise explicitly made to this. Here, the control lever has a lever arm at which a guide pin is provided which is guided in the guide track provided at the sliding door. The guide track preferably extends in the direction outwardly away from the hinge bow.

### SUMMARY OF THE INVENTION

It is the object of the invention to provide an improved hinge door of the initially set forth type.

This object is achieved in accordance with the invention by the characterizing features herein. The sliding door includes a damper for damping the movement of the sliding door on the connection of the centering to the counter-bearing. The movement of the sliding door can hereby be damped on its closing. Damage to the centering and/or to the counter-bearing on the closing of the sliding door can be avoided by the invention. It is furthermore possible to increase operating comfort.

Advantageous further developments are described herein.

The damper preferably includes a spring element. A damper in the sense of the invention can therefore be formed by a spring element. A speed-dependent damper is not required for this purpose. It is, however, possible that the damper in accordance with the invention includes a speed-dependent damper instead of the spring element or in addition to it.

The spring element can be prestressed.

It is advantageous if the direction of action of the damper extends in the longitudinal direction of the sliding door. The damping effect can thereby be improved.

A further advantageous further development is characterized in that the damper has a pin with an abutment surface for the centering. The pin is preferably longitudinally displaceably guided. It is advantageous if the pin is longitudinally displaceably journalled in the longitudinal direction of the sliding door.

The damper is preferably arranged at the counter-bearing. It is, however, also possible to provide the damper in the sliding door.

A further advantageous further development is characterized in that the centering has a centering surface which contacts a counter-surface fixed to the body with a closed sliding door. A reliable centering of the sliding door in the closed position hereby becomes possible.

The centering surface can have a section which extends in an inclined manner toward the longitudinal direction of the vehicle. The counter-surface fixed to the body is preferably made accordingly. The section of the centering surface extending in an inclined manner toward the longitudinal direction of the vehicle is preferably inclined to the front and to the inside in the direction of the vehicle. It is advantageous if the inclined section of the centering surface is planar.

A further advantageous further development is characterized in that the centering surface has a section which extends parallel to the longitudinal direction of the vehicle. The counter-surface fixed to the body is preferably made accordingly. The section extending parallel to the longitudinal direction of the vehicle is preferably disposed subsequent to a section which extends in an inclined manner toward the longitudinal direction of the vehicle. It preferably forms an end section of the centering surface.

The invention further relates to a vehicle, in particular to a motor vehicle, which is characterized by one or more sliding doors in accordance with the invention.

### BRIEF DESCRIPTION OF THE DRAWINGS

An embodiment of the invention will be explained in detail in the following with reference to the enclosed drawing. There are shown in the drawing

FIG. 1a an already known embodiment of a sliding door for a motor vehicle in the closed position in a schematic view from above;

FIG. 2 the sliding door in accordance with FIG. 1 in a partly opened position in a schematic view from above corresponding to FIG. 1;

FIG. 3 the sliding door in accordance with FIGS. 1 and 2 in the completely opened position in a schematic view from above corresponding to FIGS. 1 and 2;

FIG. 4 the front part of a sliding door in accordance with the invention of the kind shown in FIGS. 1 to 3 in a partly opened position in a schematic view from above; and

FIG. 5 the sliding door in accordance with FIG. 4 in the closed position in a view from above corresponding to FIG. 4.

### DESCRIPTION OF THE PREFERRED EMBODIMENTS

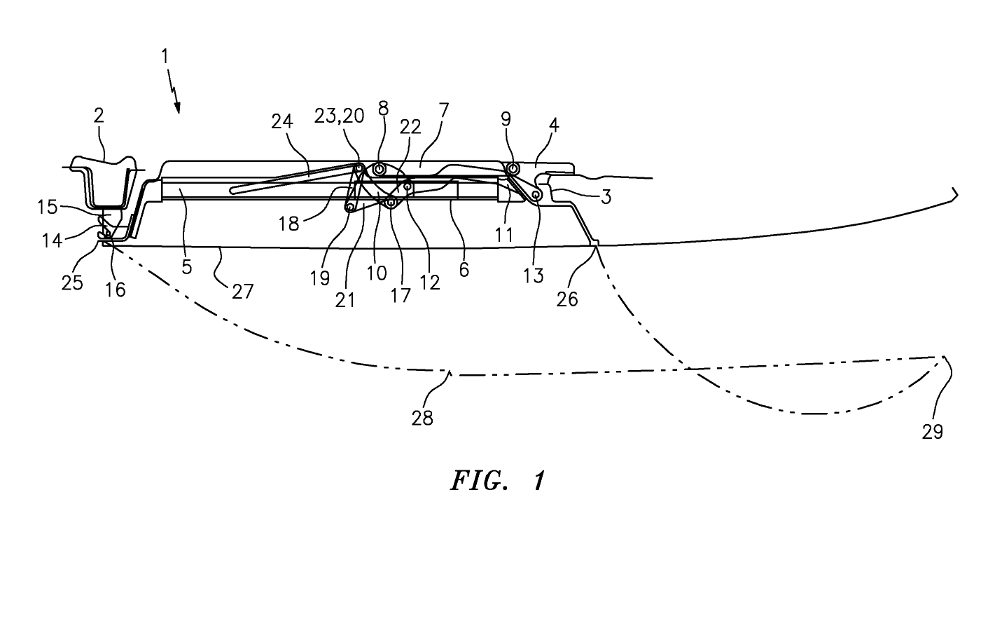

FIGS. 1, 2 and 3 show the sliding door 1 in accordance with an embodiment of DE 10 2008 016 650 B3. The sliding door 1 is the rear left hand door of a motor vehicle. It is located in the opening of the body between the B pillar 2 and a rear body part 3 in whose region a body flange 4 is connected to the body. The rear body part 3 can be the C pillar or the A pillar.

The sliding door 1 has a guide rail 5 at its inner side. A sliding carriage 6 is longitudinally displaceably journalled on the guide rail 5.

The sliding door 1 furthermore has a hinge bow 7 and a control lever 11. The hinge bow 7 is rotatably journalled about a joint 8 at the sliding carriage 6 and about a joint 9 at the body flange 4. The control lever Ills rotatably journalled about a joint 12 at the sliding carriage 6 and about a joint 13 at the body flange 4.

A first intermediate lever 10 is rotatably journalled at the control lever 11 and indeed about the axis of a joint 17. A second intermediate lever 18 is rotatably journalled at the sliding carriage 6 and indeed about the axis of a joint 19. The joint 19 is disposed in the outer region of the sliding carriage 6. It is disposed in the region of the front end of the sliding carriage 6. The ends of the intermediate levers 10, 18 remote from the joints 17, 19 are rotatably connected to one another by a joint 20. The first intermediate lever 10 and the second intermediate lever 18 form a toggle lever. Since the connection joint 20 of the intermediate levers 10, 18 is disposed further inwardly with respect to the motor vehicle than the joints 17, 19, the toggle lever formed by the intermediate levers 10, 18 is inwardly disposed with respect to the vehicle.

A joint plate 21 which carries the joints 8, 12 and 19 is fastened to the sliding carriage 6. The hinge bow 7, the control lever 11, the sliding carriage 6, the hinge plate 21 and the body flange 4 form a multijoint with the joints 8, 9, 12 and 13.

A U-shaped mount 14 which extends in an inclined manner toward the longitudinal direction of the vehicle, namely inwardly to the front in the direction of the vehicle, is provided at the sliding door 1 at the end of the sliding door 1 disposed opposite the hinge bow 7. It is open at its end remote from the hinge bow 7, in the embodiment at its front inner end. A hinge pin 16 which engages into the U-shaped mount 14 is provided at a body flange 15 which is fastened to the B pillar 2. In the completely closed position of the sliding door shown in FIG. 1, the hinge pin 16 is located at the base of the U-shaped mount 14. It can be locked there (not shown in the drawing).

The control lever 11 has an extension 22 which extends to the outside from the joint 12. The extension 22 extends the control lever 11 beyond the joint 12 along the connection line from the joint 13 to the joint 12. In this respect, the extension 22 kinks slightly outwardly or rearwardly with respect to the connection line between the joints 13 and 12, that is with respect to the longitudinal extent of the control lever 11. The joint 17 for the first intermediate lever 10 is provided at the control lever 11 in the region of the outer end of the extension 22.

A guide pin 23 which is guided in a guide track 24 is provided at the connection joint 20 of the first intermediate lever 10 and of the second intermediate lever 18. The guide track 24 is provided at the sliding door 1. The guide track 24 is accordingly therefore a guide track fixed with respect to the door. It extends in an outwardly inclined manner relative to the guide rail 5 in the direction away from the hinge bow 7. The guide track 24 is designed as continuously linear. Its inclination is the same over its total length.

In the completely closed position of the sliding door 1, which is shown in FIG. 1, the hinge pin 16 is disposed in the U-shaped mount 14, and indeed in the region of its end. The guide pin 23 is located in the region of the rear inner end of the guide track 24. The first intermediate lever 10 faces to the front and inwardly from the joint 17. The second intermediate lever 18 faces to the rear and inwardly from the joint 19.

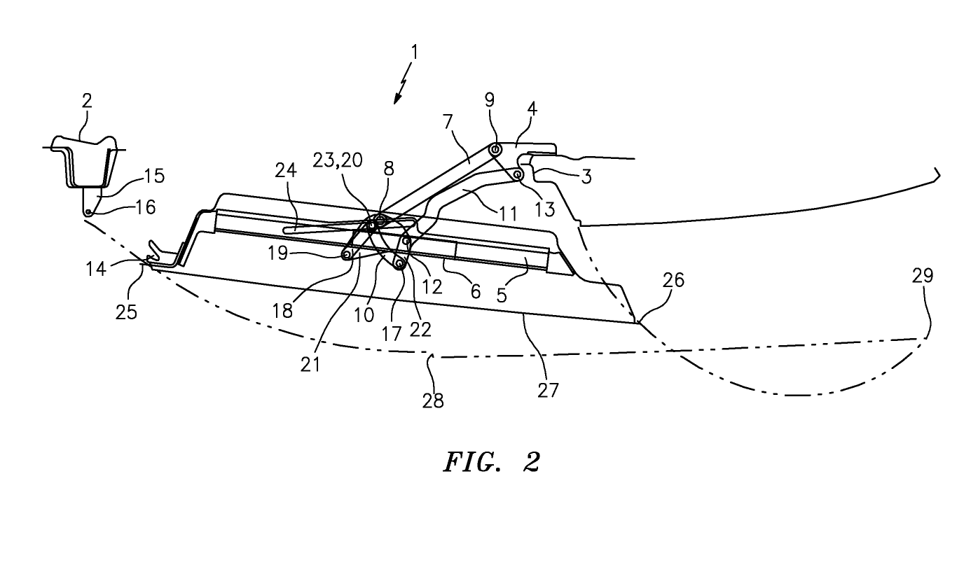

The position in accordance with FIG. 2 is passed through in the course of the opening movement. This opening movement can be produced in that the guide rail 5 is moved rearwardly relative to the sliding carriage 6. A motor, in particular an electric motor, can be present at the sliding carriage 6 for the drive of the guide rail 5 relative to the sliding carriage 6. Instead or additionally, the motor, in particular an electric motor, can be present to drive the hinge bow 7 and/or the control lever 11. It is advantageous if a motor is present at the body flange 4 or at another body part for driving the hinge bow 7 and/or the control lever 11.

The opening movement can, however, instead or additionally also be produced by hand. The guide rail 5 can in particular be moved manually to the rear relative to the sliding carriage 6. For this purpose, a handle or a plurality of handles can be provided at the sliding door 1 by which the sliding door 1 and with it the guide rail 5 can be moved relative to the sliding carriage 6. The handle can be provided at the inner front end of the sliding door 1 and/or at the outer front end of the sliding door 1 and/or at the outer rear end of the sliding door 1. The sliding door 1 can be opened and also closed again by an application of force to each of these three points.

The sliding carriage 6 could be freely displaced on the guide rail 5 without the guide pin 23. The guide pin 23 guided in the guide track 24 prevents this free displaceability and fixes the relative position of the sliding carriage 6 with respect to the guide rail 5 and thus with respect to the sliding door 1. This takes place in the sections of the guide track 24 which have an inclination different from zero with respect to the guide rail 5, that is do not extend parallel to the guide rail 5. The guide track 24 has the same inclination different from zero with respect to the guide rail 5 along its total length.

If the guide rail 5 is moved rearwardly by a motor and/or manually relative to the sliding carriage 6, the guide pin 23 guided in the guide track 24 moves outwardly relative to the guide rail 5 and to the sliding carriage 6, whereby the second intermediate lever 18 is pivoted clockwise about the joint 19. The joint 17 located at the other end of the first intermediate lever 10 is likewise moved rearwardly by the movement of the guide pin 23 relative to the sliding carriage 6, whereby the control lever 11 is rotated counter clockwise about the joint 12. The control lever 11 is hereby pivoted counter clockwise about the joint 13 at the body flange 4. The hinge bow 7 is also pivoted counter clockwise about the joint 9 by the pivoting of the control lever 11. The joint plate 21 of the sliding carriage 6 is likewise guided in a compulsory manner by the pivoting of the hinge bow 7 about the joint 9 since it forms a multijoint with the hinge bow 7, the control lever 11 and the body flange 4—as stated.

The drive movement for the opening of the sliding door 1 can, however, also be initiated in a different manner, in particular by a motor drive and/or manual drive of the hinge bow 7 and/or of the control lever 11 and/or of the first intermediate lever 10 and/or of the second intermediate lever 18 about one or more of the joints 9, 8, 13, 12, 17, 20, 19.

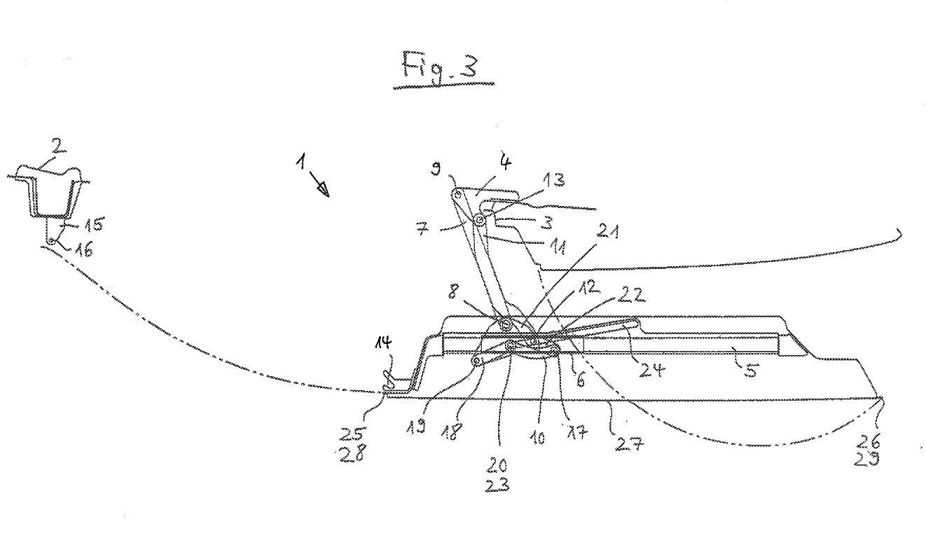

The completely open position of the sliding door 1 is shown in FIG. 3. The first intermediate lever 10 was pivoted clockwise by approximately 90° with respect to the extension 22 about the joint 17. The guide pin 23 has reached the front, closed end of the guide track 24. The second intermediate lever 18 was pivoted by approximately 45° clockwise about the joint 19 with respect to the sliding carriage 6 or the joint plate 21. The opening angle of the intermediate lever 10, 18 at the joint 20 was enlarged by approximately 30° to approximately 150°. The control lever 11 and the hinge bow 7 have been pivoted by an angle of 120° counter clockwise about the joints 13 and 9.

When the sliding door 1 should be closed, the described positions are run through in the reverse order. The closing movement of the sliding door 1 can be effected in that the guide rail 5 is moved to the front relative to the sliding carriage 6, in a motor driven and/or manual fashion. The relative movement of the guide rail 5 is transmitted by the guide track 24 to the guide pin 23 and is introduced from there via the first intermediate lever 10 into the described multijoint. It is, however, also possible to initiate the closing movement in a manner such as was described for the opening movement.

The paths of the front end 25 and of the rear end 26 of the outer door panel 27 are drawn in FIGS. 1, 2 and 3. The front end 25 of the outer door panel 27 first moves at an angle of approximately 30° rearwardly and outwardly with respect to the longitudinal axis of the vehicle. The angle of inclination of the U-shaped mount 14 corresponds to this angle. It subsequently describes an arc with a large radius whose end 28 has a tangent extending parallel to the longitudinal axis of the vehicle. The rear end 26 of the outer door panel 27 first moves approximately at a right angle away from the body and then describes an arc which becomes tighter up to an end point 29 which has substantially the same spacing from the body of the vehicle as the end point 28 of the front end 25.

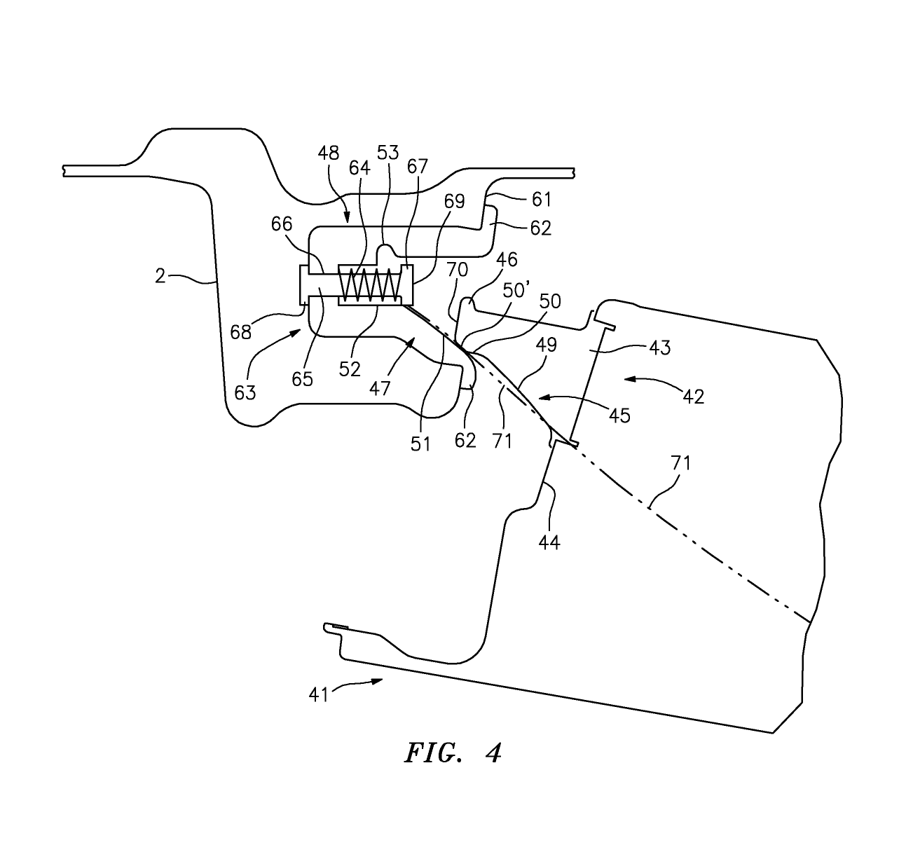

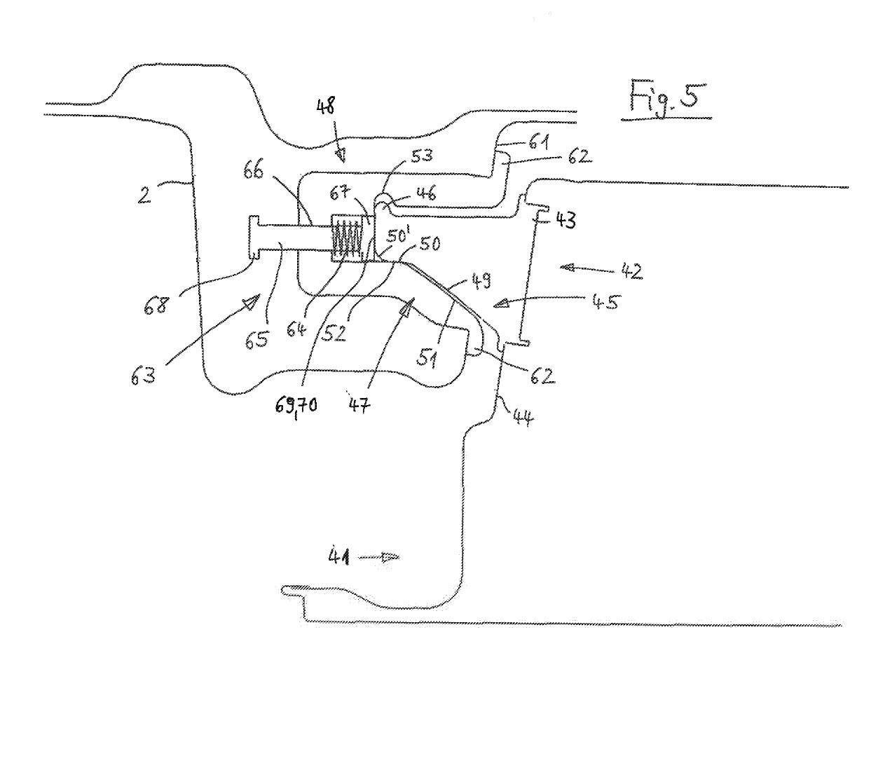

FIGS. 4 and 5 show the front part of a sliding door 41 in accordance with the invention having a centering 42 which is made differently than in the embodiment of FIGS. 1 to 3. The centering 42 is fastened to the rear end of the sliding door 41. It includes a fastening flange 43, which is fastened to a front closure panel 44 of the sliding door 41, and a centering surface 45.

The centering surface 45 contacts a counter surface 47 fixed to the body with a closed sliding door. The counter-surface 47 fixed to the body is provided at a counter-bearing 48 which is at the body side and which is fastened to the B pillar 2. The counter-bearing 48 is made in cup shape. It is located in an opening in a panel 61 of the B column 2 facing the sliding door 41. The cup-shaped counter-bearing 48 is inserted into this opening. Outer margins 62 of the counter-bearing 48 in this respect contact the margins of the panel 61 surrounding the opening. The counter-bearing 48 is located within the B pillar 2.

The centering surface 45 of the centering 42 has a section 49 which extends in an inclined manner toward the longitudinal direction of the vehicle. The section 49 is inclined to the front and inwardly in the direction of the vehicle. It is planar.

The centering surface 45 furthermore has a section 50 which extends parallel to the longitudinal direction of the vehicle. The parallel section 50 adjoins the inclined section 49. It forms the end section of the centering surface 45. The parallel section 50 is disposed in front of the inclined section 49 in the longitudinal direction of the vehicle. It has a rounded portion 50′ at its end at the front in the longitudinal direction of the vehicle.

The counter-surface 47 fixed to the body is made in a corresponding manner. It includes a planar, inclined section 51 and a parallel section 52 adjoining it. In the closed state of the sliding door, the inclined section 49 contacts the inclined section 51 and the parallel section 50 contacts the parallel section 52. In this manner, a reliable centering of the sliding door 41 in the closed position of the sliding door is made possible.

A damper 63 is provided in the counter-bearing 48. The damper 63 includes a spring element 64, namely a compression spring, and a pin 65 which is longitudinally displaceably guided in a guide 66. The guide 66 is located in the base of the cup-shaped counter-bearing 48. It extends in the longitudinal direction of the sliding door which is identical to the longitudinal direction of the vehicle. The compression spring 64 is supported at the base of the cup-shaped counter-bearing 48 and at a collar 67 at the rear end of the pin 65. The pin 65 is preloaded in the direction to the rear by the compression spring 64. Its path is bounded by a collar 68 at the front end of the pin 65 which contacts the outer surface of the base of the cup-shaped counter-bearing 48. The compression spring 64 is prestressed in this position which is shown in FIG. 4. The outer end surface of the collar 67 at the rear in the direction of the vehicle forms an abutment area 69 for the centering 42.

FIG. 4 shows the front part of the sliding door 41 in a partly opened position before the closing of the sliding door 41. The rounded portion 50′ at the front end of the parallel section 50 of the centering surface 45 of the centering 42 moves into contact with the outer rear end of the inclined section 51 of the counter surface 47 fixed to the body and subsequently slides to the front and inwardly along the inclined section 51. Before the rounded section 50′ at the front end of the parallel section 50 reaches the front inner end of the inclined section 51, the front end surface 70 of the centering 42 comes into contact with the abutment surface 69 of the pin 65. During the further movement of the centering 42 to the front, the pin 65 is pressed to the front against the force of the compression spring 64. The compression spring 64 in this manner damps the sliding door 41 on the connection of the centering 42 to the counter-bearing 48. The closing movement of the sliding door 41 is therefore damped.

When the rounded portion 50′ at the front end of the parallel section 50 of the centering surface 45 of the centering 42 reaches the front inner end of the inclined section 51 of the counter surface 47 of the body flange 48 fixed to the body, there is subsequently an exclusive movement to the front which is ended when the inclined section 49 completely contacts the inclined section 51, as shown in FIG. 5. In this position, the sliding door 41 is completely and reliably latched. The compression spring 64 is also further compressed during this movement directly exclusively to the front. As the closing of the sliding door 42 increases, the force of the compression spring 64 set against the closing movement becomes greater so that an increasingly better damping effect arises.

The reverse path is run through on the opening of the sliding door 41. The opening movement is supported by the compression spring 64. On the opening movement, the centering 42 is moved rearwardly and outwardly out of the position shown in FIG. 6. Due to the parallel section 50 of the centering surface 45 of the centering 42 and of the associated parallel section 52 of the counter surface 47 of the body flange 48 fixed to the body, the centering 42 first moves exclusively rearwardly. A movement is then outwardly superimposed by the inclined sections 49, 51 when the length of the parallel section 50 has been overcome. The centering 42 then moves uniformly rearwardly and outwardly. During this movement, the rounded portion 50′ at the front end of the parallel section 50 of the centering surface 45 slides rearwardly and outwardly on the inclined section 51 of the counter surface 47 fixed to the body. The end of this sliding movement is shown in FIG. 5 in which the rounded portion 50′ at the front end of the parallel section 50 is located at the rear, outer end of the inclined section 51. The centration 42 then rises from the counter surface 47 fixed to the body. The rounded portion 50′ follows the profile curve 71.

An arresting hook 46 is provided at the centering 42. The arresting hook 46 is located at the front end of the centering 42. It is disposed opposite the parallel section 50 of the centering surface 45. The arresting hook 46 is inwardly directed in the longitudinal direction of the vehicle. A counter-piece 53 fixed to the body is disposed opposite said arresting hook when the sliding door is closed. The counter-piece 53 is provided at the counter-bearing 48. It is disposed at the same level as the arresting hook 46 and within the arresting hook 46 in the longitudinal direction of the vehicle with a closed sliding door. If the sliding door 41 is inwardly deformed on a side impact, the arresting hook 46 moves into contact with the counter-piece 53 fixed to the body, whereby an anchoring is formed for the sliding door 41 which sets a resistance against a deformation of the sliding door 41 to the inside.

1. A sliding door for a vehicle having a guide rail (5), having a sliding carriage (6) which is longitudinally displaceably journalled at the guide rail (5) connected to the vehicle body by a multijoint (7, 11, 6, 4) and having a centering (42) at its end remote from the multijoint (7, 11, 6, 4) which is releasably connectable to a counter-bearing (48) at the body side, and
a damper (63) for damping the movement of the sliding door (41) on the connection of the centering (42) to the counter-bearing (48).

2. A sliding door in accordance with claim 1, wherein the damper (63) includes a spring element (64).

3. A sliding door in accordance with claim 2, wherein the spring element (64) is prestressed.

4. A sliding door in accordance with claim 1, wherein the direction of action of the damper (63) extends in the longitudinal direction of the sliding door (41).

5. A sliding door in accordance with claim 1, wherein the damper (63) has a pin (65) having an abutment surface (69) for the centering (42).

6. A sliding door in accordance with claim 1, wherein the damper (63) is arranged in the counter-bearing (48).

7. A sliding door in accordance with claim 1, wherein the centering (42) has a centering surface (45) which contacts a counter-surface fixed to the body with a closed sliding door.

8. A sliding door in accordance with claim 7, wherein the centering surface (45) has a section (49) which extends in an inclined manner to the longitudinal direction of the vehicle.

9. A sliding door in accordance with claim claim 7, wherein the centering surface (45) has a section (50) which extends parallel to the longitudinal direction of the vehicle.

10. A vehicle, in particular a motor vehicle, having one or more sliding doors in accordance with claim 1.

11. A sliding door in accordance with claim 3, wherein the direction of action of the damper (63) extends in the longitudinal direction of the sliding door (41).

12. A sliding door in accordance with claim 2, wherein the direction of action of the damper (63) extends in the longitudinal direction of the sliding door (41).

13. A sliding door in accordance with claim 12, wherein the damper (63) has a pin (65) having an abutment surface (69) for the centering (42).

14. A sliding door in accordance with claim 11, wherein the damper (63) has a pin (65) having an abutment surface (69) for the centering (42).

15. A sliding door in accordance with claim 4, wherein the damper (63) has a pin (65) having an abutment surface (69) for the centering (42).

16. A sliding door in accordance with claim 3, wherein the damper (63) has a pin (65) having an abutment surface (69) for the centering (42).

17. A sliding door in accordance with claim 2, wherein the damper (63) has a pin (65) having an abutment surface (69) for the centering (42).

18. A sliding door in accordance with claim 13, wherein the damper (63) is arranged in the counter-bearing (48).

19. A sliding door in accordance with claim 14, wherein the damper (63) is arranged in the counter-bearing (48).

20. A sliding door in accordance with claim 15, wherein the damper (63) is arranged in the counter-bearing (48).
